(19) United States
(12) Patent Application Publication
(10) Pub. No.: US 2018/0169779 A1
(43) Pub. Date: Jun. 21, 2018

(54) A MACHINE REAMING TOOL, INTERCHANGEABLE HEAD AND SHANK FOR A MACHINE REAMING TOOL

(71) Applicant: Urma AG, Rupperswil (CH)

(72) Inventors: Urs Berner, Aarau (CH); Gilbert Zumsteg, Obfelden (CH)

(21) Appl. No.: 15/549,733

(22) PCT Filed: Feb. 8, 2016
(86) PCT No.: PCT/CH2016/000026

§ 371 Date: Aug. 9, 2017

(30) Foreign Application Priority Data
Feb. 11, 2015 (CH) 184/15

(51) Int. Cl. B23D 77/02

(52) U.S. Cl. CPC B23D 77/02; B23B 2231/0204; B23D 2277/205; B23D 2277/203; B23D 2277/02

(57) ABSTRACT

A machine reaming tool includes a shank and an interchangeable head assembled on the shank. The interchangeable head on a side that faces the shank includes at least one head groove and at least one head ridge. The shank on a side that faces the interchangeable head includes at least one shank groove and at least one shank ridge. In the assembled condition, the at least one head groove engages into the at least one shank ridge and the at least one shank groove engages into the at least one head ridge.

### BACKGROUND OF THE INVENTION

### Field of the Invention

The invention relates to a machine reaming tool, to an interchangeable head and to a shank for a machine reaming tool.

### Description of Related Art

Machine reaming tools or machine reamers are used for the precision machining of cylindrical bores. Individual teeth each include a primary cutting edge or leading cut portion and a secondary cutting edge or guide portion. The leading cut portion performs the cutting work and the guide portions serves for guiding the tool in the bore. In order to ensure a reliable guidance under all machining conditions, for example in the case of an oblique exit out of the bore, the guide portion is a multiple of the length of the leading cut portion in the axial direction. The length of the guide portion is therefore 10 millimetres or more, given a diameter for example of approx. 15 millimetres. A blade of the guide portion runs parallel to the rotation axis of the tool in the case of a straight fluted cutter (insert). In case of a helically fluted cutter, the blade of the guide portion runs obliquely to the rotation axis of the tool. US 2007/067979 of the same applicant describes a modular machine reaming tool with interchangeable heads with a thickness (and thus of a corresponding length of the guide portion) of less than 6 mm. The diameter of such interchangeable heads should be at least 10 mm or 12 mm.

U.S. Pat. No. 2,303,487 discloses a reaming tool with an interchangeable head, concerning which the shank includes a groove and the interchangeable head includes a projecting ridge. In the assembled condition, the ridge engages into the groove and transmits a drive moment onto the interchangeable head. The ridge and groove, however, do not contribute to the exchange accuracy; this is ensured by a central cylindrical connection. However, the achievable exchange accuracy is therefore limited.

Concerning such a modular system, the problem of ensuring the transmission of force from the shank onto the interchangeable head arises with an increasingly small diameter of the interchangeable head. A positive force transmission as in U.S. Pat. No. 2,303,487 lends itself, but it must be able to be simply created and simultaneously permit a high exchange (interchanging) accuracy. This is not possible with known systems.

EP 1 739 849 discloses an end mill with an interchangeable head, in which a groove and a web are present for centering and moment transmission. These run at a right angle to one another and each have a rectangular cross section. It is to be emphasised that surfaces that run as perpendicularly as possible to one another are present in this manner, so that the precise manufacture is simplified. However, it has been found that the positioning accuracy and, in particular, the interchanging accuracy or repeatability is limited. On account of the right-angled cross sections, a certain minimal tolerance must be present so that the shank and the head can be assembled. This required tolerance limits the exchange accuracy.

US 2008/0193238 discloses a drill with a self-clamping fastening of the interchangeable head. Projections and indentations on the head and shank form a type of bayonet closure, with which the head can be assembled on the shank without further fastening means.

EP 1 506 069 concerns the avoidance of mix-ups of different tool types. A cutting plate includes a plane surface with three axially projecting ribs (each at an angle of 120° to one another) for connection to a holder, and the holder includes corresponding grooves. Side flanks of the ribs or grooves form driver surfaces for the transmission of torque and run obliquely to the mentioned plane surface. The support of the cutting plate is effected via these surfaces, and a small play remains between the plane surface of the cutting plate and an opposite annular surface of the holder (cf. paragraph [0015]. However, a highly precise manufacture is not possible or very expensive due to the arrangement of the ribs and grooves.

DE 10 2009 030 470 discloses a shank and an interchangeable head with a driver, e.g., for a reaming tool.

### SUMMARY OF THE INVENTION

It is therefore the object of the invention to provide a machine reaming tool, an interchangeable head and a shank for a machine reaming tool of the initially mentioned type, which overcome the disadvantages mentioned above.

A further object is to increase the exchange accuracy compared to known systems.

A further object is the realisation of interchangeable heads with smaller diameters than was hitherto the case.

At least one of these objects is achieved by a machine reaming tool, an interchangeable head and a shank for a machine reaming tool, with the features of the respective independent patent claims.

The machine reaming tool includes a shank and an interchangeable head which is assembled on this. Here
the interchangeable head on a side which faces the shank includes at least one head groove and at least one head ridge,
the shank on a side that faces the interchangeable head includes at least one shank groove and at least one shank ridge, and
in the assembled condition, the at least one head groove engages into the at least one shank ridge and the at least one shank groove engages into the at least one head ridge.

The head groove can be considered as a recess in a head end-face and the head ridge as projecting beyond the head end-face, wherein the head end-face runs normally to a rotation axis or longitudinal axis of the machine reaming tool and of the interchangeable head. Here, the head end-face can be subdivided by the head groove, the head ridge and a bore into several part-surfaces.

The shank groove can be considered as a recess in a shank end-face and the shank ridge as projecting beyond the shank end-face, wherein the shank end-face runs normally to a rotation axis or longitudinal axis of the machine reaming tool and of the shank. Here, the shank end-face can be subdivided by the shank groove, the shank ridge and a bore into several part-surfaces.

If they cross and/or one another or if they cross a bore, the ridges and grooves on the shank and head can each be subdivided into part-ridges or part-grooves. For example, the head ridge can be broken down into two part-ridges. Side walls of a ridge—which are decisive for the function of the head ridge by way of them defining the position of the interchangeable head in a direction normal to the rotation axis—can also be broken down into separate part-surfaces which however each lie in the same plane. Together, they assume the function as a contact surface of the head ridge. This analogously applies to the head groove, the shank groove and to the shank ridge.

The mentioned part-surfaces of a ridge or a groove can be ground by the same tool in one operation on account of them lying in the same plane. This mutual position (lying in the same plane) can be manufactured with a high precision in this manner—in contrast, for example, to surfaces that lie at an angle of 120° to one another.

The head ridge and the shank groove define the relative position between the interchangeable head and the shank in a first direction (normal to the direction of the head ridge and shank groove). The head groove and the shank ridge define the relative position in a second direction (normal to the direction of the head groove and shank ridge). In an embodiment, the first and the second direction are normal to the rotation axis. In an embodiment, the first and the second direction are normal to one another.

If one of the parts—the interchangeable head or shank—were only to include grooves and the other only ridges, then the part with only grooves would be weakened with respect to a maximally transmittable torque. The maximally transmittable torque as a whole is higher due to both parts including grooves as well as ridges.

In the assembled condition, the head end-face can be pressed towards the shank end-face of the shank in a direction parallel to the rotation axis, by way of a fastening element. The end-faces are therefore pressed towards one another in this direction, but preferably do not contact one another.

In embodiments, the grooves and ridges on the interchangeable head and the shank each include oblique side walls, and in the assembled condition a fastening element, which presses the interchangeable head towards the shank in one direction (typically in the direction of the rotation axis of the tool), presses the oblique side walls of the head groove against those of the shank ridge and the oblique side walls of the head ridge against those of the shank groove.

A wall or plane is indicated as “oblique” if it neither lies normally nor parallel to the rotation axis. The angle between the plane and the rotation axis is larger than zero and smaller than 90°.

At least a line contact between surfaces pressed against one another can be realised by way of the side walls being oblique. The positioning accuracy is improved with this. Only a point contact is realised with side walls, which run parallel to the rotation axis, for example in the case of the initially mentioned EP 1 738 849.

The “direction” or “axis” of a groove or of a ridge is to be understood as its longitudinal axis. The side surfaces and base surface (of a groove) and end-face (of a ridge) are part of the lateral surface of a general cylinder formed by way of displacing a generatrix (also called surface line) along the longitudinal axis of the groove and the ridge, respectively. In particular, the general cylinder can be a prism, in particular straight prism.

In embodiments
two inner side walls of the head groove taper to one another in the direction of a base surface of the head groove and form two head groove contact surfaces, and two outer side walls of the head ridge taper to one another in the direction of an end-face of the head ridge and form two head ridge contact surfaces;
two inner side walls of the shank groove taper to one another in the direction of a base surface of the shank groove and form two shank groove contact surfaces, and two outer side walls of the shank ridge taper to one another in the direction of the end-face of the shank ridge and form two shank ridge contact surfaces; and
in the assembled condition, the head groove contact surfaces lie on the ridge shank contact surfaces and the head ridge contact surfaces lie on the shank groove contact surfaces.

In embodiments, at least one and in particular all of the three following features are present in the assembled condition:
the head end-face and the shank end-face do not contact one another;
the end-face of the head ridge and the base surface of the shank groove do not contact one another;
the base surface of the head groove and the end-face of the shank ridge do not contact one another.

In embodiments
the two inner side walls of the head groove are plane, and two planes, in which the two inner side walls of the head groove lie, intersect at a line which intersects the rotation axis and lies normally to this (the intersection point of this line and of the rotation axis lies on a section of the rotation axis which is at the head side).
the two outer side walls of the head ridge are plane, and two planes, in which the two outer side walls of the head ridge lie, intersect at a line that intersects the rotation axis and lies normally to this (the intersection point of this line and of the rotation axis lies on a section of the rotation axis which is at the shank side).
the two inner sides walls of the shank groove are plane, and two planes, in which the two inner side walls of the shank groove lie, intersect at a line which intersects the rotation axis and lies normally to this (the intersection point of this line and of the rotation axis lies on a section of the rotation axis which is at the shank side).
the two outer side walls of the shank ridge are plane, and two planes, in which the two outer side walls of the shank ridge lie, intersect at a line that intersects the rotation axis and lies normally to this (the intersection point of this line and of the rotation axis lies on a section of the rotation axis which is at the head side).

Considered differently: the head groove and the head ridge and likewise the shank groove and the shank ridge run normally to a rotation axis or longitudinal axis of the machine reaming tool and are each symmetrical with regard to a rotation about the rotation axis by 180°.

In embodiments, the shank ridge includes a slot in the longitudinal direction, thus parallel to the direction, in which the shank ridge runs. By way of this, in the assembled condition—relative to the non-assembled condition—the outer side walls of the shank ridge are pressed against one another, the shank ridge is deformed and the slot is narrowed.

A geometric over-definition along the direction of the longitudinal axis and which could otherwise be present on connecting the shank and the head via the two ridge-groove connections can be eliminated by way of this deformation.

In embodiments, the head groove and the head ridge run normally to one another and the shank groove and the shank ridge run normally to one another (considered in a projection along the rotation axis in each case).

In embodiments, which are particularly suitable for small diameters of the interchangeable head, the fastening element is an axially centred cap screw.

In embodiments, coolant feeds arranged on the shank each lead to a chip space in front of the teeth of the interchangeable head. Here, the number of coolant feeds in particular is equal to the number of teeth.

The division of the teeth, in particular of the primary cutting edges or leading cut portions, according to embodiments is selected such that the following criteria are fulfilled as much as possible:
walls between the coolant feeds and the separating location to the interchangeable head are weakened as little as possible on the shank. In particular, a distance between the shank ridge and the coolant feed does not fall short of a minimal value;
the interchangeable head can also be applied onto the shank in a manner rotated by 180° about the rotation axis. In other words: the arrangement of the teeth and of the chip spaces with respect to the shank is independent of the two possible positions, in which the interchangeable head is assembled on the shank;
the division is not exactly uniform. This counteracts vibrations on operation.
interchangeable heads with straight fluted and helically fluted teeth should be able to be assembled onto the same shank.

Here, the division of the teeth can be dependent on the diameter of the interchangeable head. The invention can therefore also to a set of machine reaming tools with different diameters of the individual machine reaming tools, wherein different divisions of coolant feeds are present on the shanks of the machine reaming tools and different divisions of the teeth are present on the heads of the machine reaming tools, depending on this diameter, even if the same number of teeth is present.

The coolant feeds can be realised by bores in the shank. The coolant feeds can be realised by way of grooves on the periphery of the shank, wherein a sleeve which forms an outer wall of the coolant feeds is arranged around the shank.

The interchangeable head for a machine reaming tool includes a rotation axis, wherein
at a side, which is envisaged for assembly on a shank, the interchangeable head includes at least one head groove and at least one head ridge.

Further characteristics of the interchangeable head are already described as a whole in conjunction with the tool. Particularly applicable to the interchangeable head:

In embodiments of the interchangeable head, the head groove and the head ridge each include oblique side walls. In particular
two inner sides walls of the head groove taper to one another in the direction of a base surface of the head groove and form two head groove contact surfaces, and two outer side walls of the head ridge taper to one another in the direction of an end-face of the head ridge and form two head ridge contact surfaces.

In embodiments of the interchangeable head
the two inner sides walls of the head groove are plane, and two planes, in which the two inner side walls of the head groove lie, intersect at a line that intersects the rotation axis and lies normally to this (the intersection point of this line and of the rotation axis lie on a section of the rotation axis which is at the head side).
the two outer side walls of the head ridge are plane, and two planes, in which the two outer side walls of the head ridge lie, intersect at a line that intersects the rotation axis and lies normally to this (the intersection point of this line and of the rotation axis lies on a section of the rotation axis which is at the shank side).

In embodiments of the interchangeable head, the inner side walls of the head groove and/or the outer side walls of the head ridge are inclined by an angle of between 10° and 40° and in particular by an angle of 20° with respect to the rotation axis.

In embodiments of the interchangeable head, the diameter of the interchangeable head is between 5 mm and 20 mm, in particular between 6 mm and 16 mm.

In embodiments of the interchangeable head, the thickness of the interchangeable head including the head ridge is less than 10 mm, in particular less than 8 mm and in particular less than 6 mm.

In embodiments of the interchangeable head, the coolant feeds each lead to chip spaces irrespectively of whether these feeds are realised by way of grooves or by way of bores. The chip spaces—seen in the movement direction of the tool—are each arranged in front of the teeth. The number of coolant feeds on the shank is therefore typically equal to the number of teeth on the interchangeable head.

The interchangeable head is typically a reaming head for reaming a bore. The interchangeable head typically consist of a hard metal (carbide) or cermet or of a comparable material.

The shank for a machine reaming tool includes a rotation axis, wherein
the shank at a side, which is envisaged for assembly on an interchangeable head, includes at least one shank groove and at least one shank ridge.

Further characteristics of the shank have already been described in the context of the tool as a whole.

In embodiments of the shank, the shank ridge includes a slot in the longitudinal direction (thus parallel to the direction, in which the shank ridge runs), the slot extending into the shank ridge in a manner proceeding from an end-face of the shank ridge.

In embodiments of the shank, the depth of the slot is at least as much as a height of the shank ridge beyond a shank end-face from which the shank ridge rises. This is typically also the shank end-face, in which the shank groove forms a recess.

In embodiments of the shank, this is manufactured of steel at least in a connecting region, on which the shank ridge—and typically also the shank end-faces—is formed. The steel is typically an alloyed tool steel. Alloyed tool steels with regard to their properties are characterised by at least one alloy element, whose share lies above a specific limit according to DIN 10 020. Here, the shank therefore consist of a material that is different to that of the tool head and, in particular, not of a hard metal or cermet.

The shank as a whole can be manufactured of steel. Alternatively, the shank can be manufactured of a hard metal and only of steel in the connecting region. For this, a connecting piece of steel can be fastened, for example by way of soldering, onto a rear part of the shank, which is of another material, for example of a hard metal. With this, the compressibility of the shank ridge can be ensured by way of the steel, which is relatively soft in comparison to the hard metal.

It is possible to achieve exchange accuracies of 10 micrometers or 6 micrometers and in particular of 4 micrometers by way of this.

Further preferred embodiments are to be derived from the dependent patent claims. Here, the features of the machine reaming tool as a whole can be combined with the features of the interchangeable head and the shank considered individually and vice versa.

### BRIEF DESCRIPTION OF THE DRAWINGS

The subject-matter of the invention is hereinafter explained in more detail by way of preferred embodiment examples which are represented in the accompanying drawings. Schematically represented in each case are:

FIG. 1 is an exploded drawing of a machine reaming tool;

FIG. 2 shows a head-side end of a shank;

FIG. 3 shows an interchangeable head;

FIG. 4a-c are views of a blank for an interchangeable head;

FIGS. 5a-b are views of the head region of the tool;

FIG. 6a-f show details of the connections between the interchangeable head and the shank;

FIG. 7 shows a shank and an interchangeable head, in a front view and cross section;

FIG. 8 shows a shank with four coolant channels;

FIG. 9 shows a shank with one coolant channel;

FIG. 10 shows a shank with coolant grooves; and

FIG. 11-15 are different divisions of coolant feed and teeth.

### DETAILED DESCRIPTION OF THE INVENTION

Basically, the same or equally acting parts are provided with the same reference numerals in the figures.

FIG. 1 shows an exploded drawing of a machine reaming tool with an interchangeable head 1 and with a shank 2 and with a cap screw 3 for fastening the interchangeable head 1 on the shank 2. The location, at which the interchangeable head 1 bears on the shank 2 is also called the separating location. A rotation axis 31 of the tool is identical to the rotation axis 31 of the shank 2 and of the interchangeable head 1 and is also the longitudinal axis as well as the axis of symmetry of these parts.

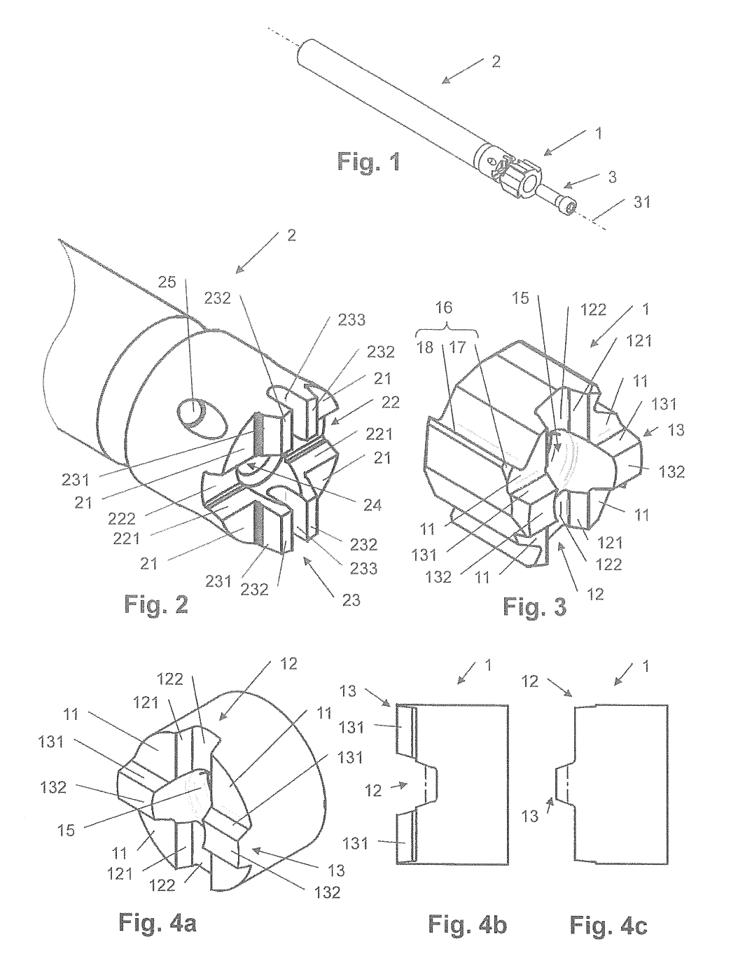

FIG. 2 shows a head-side end of a shank 2, which includes a shank groove 22 and a shank ridge 23 that runs normally to this. Taking the shank end-face 21 as a reference, the shank groove 22 can be considered as a recess and the shank ridge 23 as a projection. The shank groove 22 and the shank ridge 23 run normally to the rotation axis 31. A bore, in particular a threaded bore 24 runs in the direction of the rotation axis 31 in the region, in which the shank groove 22 and the shank ridge 23 cross one another.

The shank groove 22 at its two sides includes two inner side walls. These are oblique, thus are not parallel to the rotation axis 31, and, proceeding from the shank end-face 21, taper to one another in the direction of a base surface 222 of the shank groove 22.

The shank ridge 23 at its two ends includes two outer side walls. These outer side walls are oblique and, proceeding from the shank end face 21, taper to one another in the direction of an end-face 232 of the shank ridge 23.

The side walls of the shank groove 22 and of the shank ridge 23 form contact surfaces 221 of the shank groove 22 and contact surfaces 231 of the shank ridge 23, on which contact surfaces the interchangeable head 1 bears with correspondingly shaped contact surfaces.

The shank ridge 23 includes a slot 233, which extends along the shank ridge 23 and parallel to the rotation axis 31 of the shank 2 from the ridge end-face 232 into the shank 2. Here, it can extend further into the shank 2 than a plane of the shank end-face 21. The shank ridge 23 can be compressed thanks to the slot 233, i.e. it can elastically deform given an applied interchangeable head 1 and by way of this can compensate inaccuracies in the mutual position of the contact surfaces of the interchangeable head 1 and the shank 2.

The shank 2 moreover includes coolant channels 25.

FIG. 3 shows an interchangeable head 1. This head includes a head groove 12 and a head ridge 13, which runs normally to this. Taking the head end-face 11 as a reference, the head groove 12 can be considered as a recess and the head ridge 13 as a projection. The head groove 12 and the head ridge 13 run normally to the rotation axis 31. A bore for receiving the cap screw 3 runs in the direction of the rotation axis 31 in the region, in which the head groove 12 and the head ridge 12 cross one another.

The head groove 12 at its two sides includes two inner side walls. These are oblique, and thus are not parallel to the rotation axis 31, and, proceeding from the head end-face 11, taper to one another in the direction of a base surface 122 of the head groove 12.

The head ridge 12 at its two sides includes two outer side walls. These are oblique and, proceeding from the head end-face 11, taper to one another in the direction of an end-face 132 of the head ridge 13.

The side walls of the head groove 12 and of the head ridge 13 form contact surfaces 121 of the head groove 12 and contact surfaces 131 of the head ridge 12, on which contact surfaces the shank bears with correspondingly shaped contact surfaces.

The interchangeable head 1 includes several teeth 16, which are distributed about its periphery and which each form a leading cut portion 17 and a guiding portion 18 of the tool, in particular of a reaming tool.

FIGS. 4a-c show views of a blank for an interchangeable head. The elements described in conjunction with FIG. 3 are present with the exception of the cutting edges.

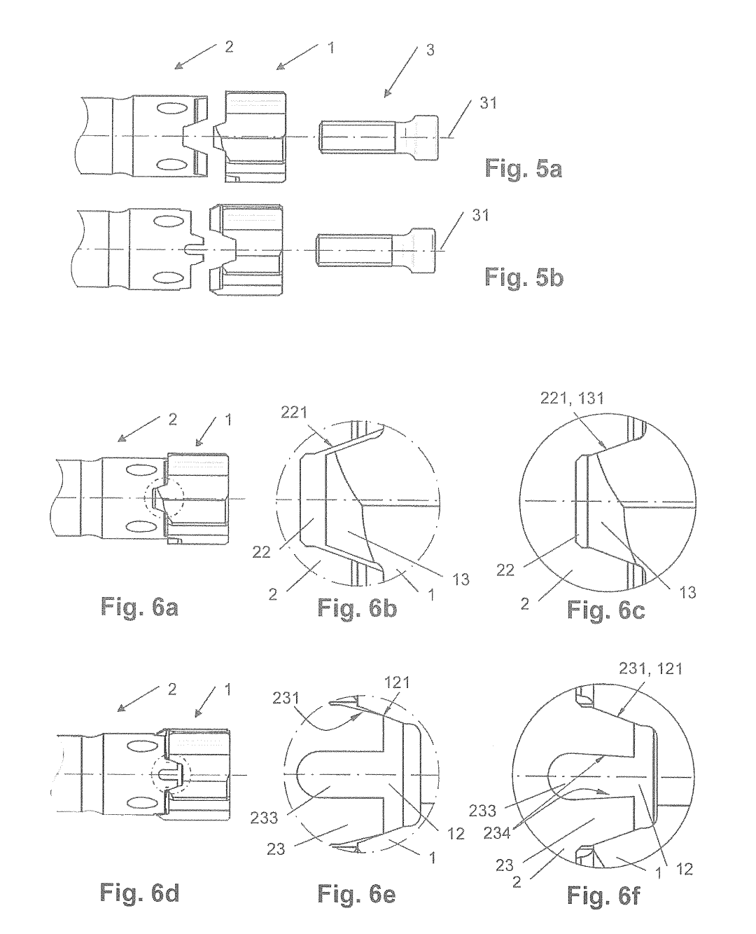

FIGS. 5a-b show views of the head region of the tool in a disassembled condition. In the lower view, the elements of the tool are rotated about the rotation axis 31 by 90° with respect to the upper view.

FIGS. 6a-f show details of the connections between the interchangeable head and the shank,
with views 6a and 6d corresponding to those of FIGS. 5a-b, but in the assembled condition, and
detailed views 6b and 6e shortly before the interchangeable head 1 and the shank 2 contact one another, and
detailed views 6c and 6f with the interchangeable head 1 and the shank 2 in the assembled and pressed-together condition.

The relative position of the interchangeable head 1 and shank 2 is defined
a) on the one hand by the mutual position of the contact surfaces 121 of the head groove 12 and of the contact surfaces 231 of the shank ridge 23, and
b) on the other hand by the mutual position of the contact surfaces 131 of the head ridge 13 and of the contact surfaces 221 of the shank groove 22.

The mutual position of the interchangeable head 1 and the shank 2 along the rotation axis 31 and the mutual position along an axis, which runs normally to the direction of the head groove 12 or to the direction of the shank ridge 23, and typically also normally to the rotation axis 31 are defined by the contact surfaces according to a). The mutual position in the direction of the head groove 12 or of the shank ridge 23 is not defined.

The mutual position of the interchangeable head 1 and the shank 2 along the rotation axis 31 and the mutual position along an axis, which runs normally to the direction of the head ridge 13 or to the direction of the shank groove 22, and typically also normally to the rotation axis 31 are defined by the contact surfaces according to b). The mutual position of the shank groove 22 in the direction of the head ridge 13 or the shank groove 22 is not defined.

The mutual position along the rotation axis 31 is thus defined twice and is therefore statically over-defined. One of the elements of the system of contact surfaces is realised in a compliant manner for compensating inaccuracies which could lead to problems on account of this static over-defining. In the present example this is the shank ridge 23, for example by way of a slot 233 running along the shank ridge 23 as has already been described. The two contact surfaces 231 of the shank ridge 23 are elastically deformable to one another by way of this.

FIGS. 6e and 6f show the deformation of the shank ridge 23 on pressing the interchangeable head 1 onto the shank 2. The connection is not yet loaded in FIG. 6e and in FIG. 6f the two halves of the shank ridge 23, which are separated from one another by the slot 233, are deformed by the pressed-on interchangeable head 1. The two halves and inner sides 234 of the slot 233 are moved towards one another by way of this.

FIG. 6e also shows that a first inclination of the contact surfaces 121 of the head groove 12 can differ from a second inclination of the contact surfaces 231 of the shank ridge 23 (in the non-loaded condition). Here, the inclination is the angle between the plane of the respective contact surfaces and the rotation axis 31. The first inclination can be somewhat larger than the second inclination. The second inclination becomes larger on deformation of the shank ridge 23 and adapts to the first inclination.

On manufacture of the interchangeable head 1 and the shank 2, the difference of the mentioned first and second inclinations can be achieved by way of the first inclination being manufactured with a minus tolerance as is usually the case, but the second inclination with a plus tolerance.

This can mean that the first inclination is equal to a nominal angle, for example between 10° and 40° and in particular equal to 20°, with a tolerance between 0° and −0.06°, and the second inclination is equal to the same nominal angle but with a tolerance between 0° and +0.06°.

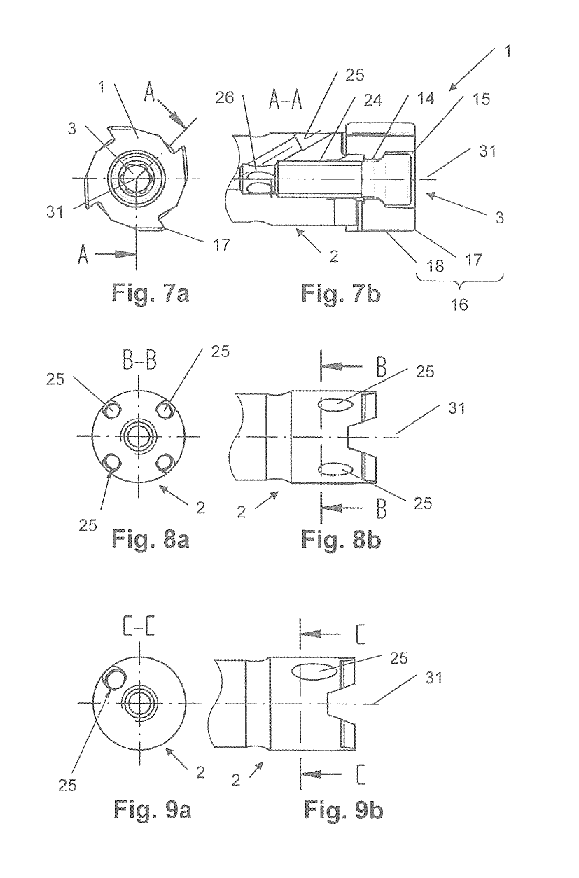

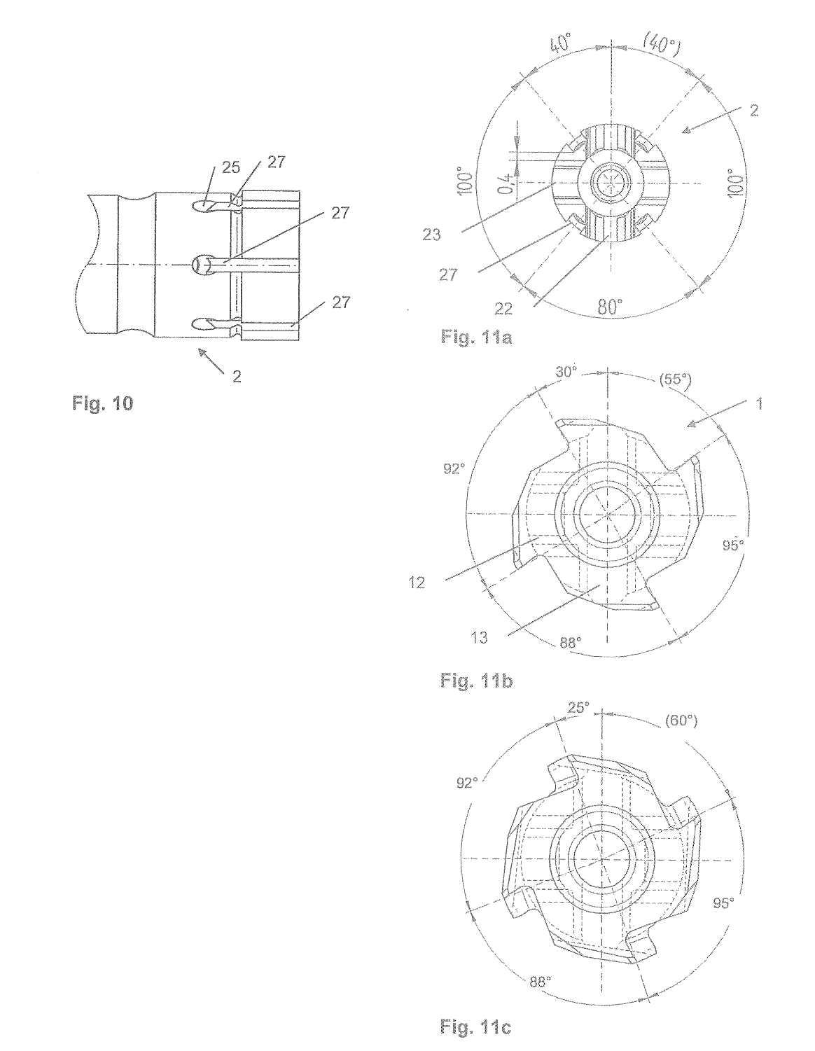

FIGS. 7a-b show a shank and an interchangeable head in a front elevation and cross section. An axial bore 26 of the shaft 2 is visible additionally to the already described elements, through which bore coolant can be led to one or more coolant channels 25. The cap screw 3 is screwed into a threaded bore 24 of the shank 2 and presses the interchangeable head 1 onto the shank 2. The cross section of FIG. 7b can correspond to an embodiment according to FIGS. 8a-b with four coolant channels 25 or to an embodiment according to FIGS. 9a-b with only one coolant channel 25. Each tooth 16 can be supplied individually in the case of four coolant channels 25. Here, a discharge of the coolant (with chips) is envisaged through the bore which is reamed.

If six or more teeth are present, then typically an equal number of six or more coolant feeds respectively are each led to the cutting spaces in front of the teeth.

The embodiment with only one or possibly also two coolant channels 25 is advantageous for blind holes, since here a region along the periphery of the interchangeable head 1 which is not supplied by the coolant channel or channels 25 can serve for the return of the coolant (with chips).

FIG. 10 shows a shank 2 in a lateral view (ridge and groove of the separating location are not represented), wherein the coolant channels 25 run out into coolant grooves 27. The coolant grooves 27 run in the longitudinal direction on the outer periphery of the shank in the direction of the interchangeable head or separating location. The coolant grooves 27 form coolant feeds to the interchangeable head 1 in the case of a cylindrical sleeve arranged around the shank.

FIGS. 11-15 show different divisions of coolant feed and teeth for different diameters. These optimise the initially mentioned criteria. Concerning the diameters, it is a nominal diameter of a blank, from which the finished cutter (insert) having different cutting diameters can be manufactured, which is taken as the basis. An optimal division is represented for the different diameters. In each case, the specified positions of the coolant feed conduits or teeth can vary by +/−2° or +/−5°. The coolant feeds shown here are realised by way of coolant grooves 27, but can also be realised by channels in the shank. A distance between the shank ridge and the coolant feed is also drawn and specified in millimetres in each case. The part of the figures that is indicated by a shows the division for the respective shank. The part of the figures that is indicated by b shows the division for an interchangeable head with straight fluted teeth. The part of the figures that is indicated by c shows the division for an interchangeable head with helically fluted teeth (in particular left helically fluted teeth). The position of the grooves or ridges of the separating location is the reference concerning the specification of the angle. The angles are specified starting from a symmetry line of the shank groove or head ridge, each in the anticlockwise direction with an external view onto the shank or head.

FIG. 11 shows divisions for an interchangeable head with a nominal diameter of 7 mm, for diameters of the finished cutter of below approx. 7 mm.

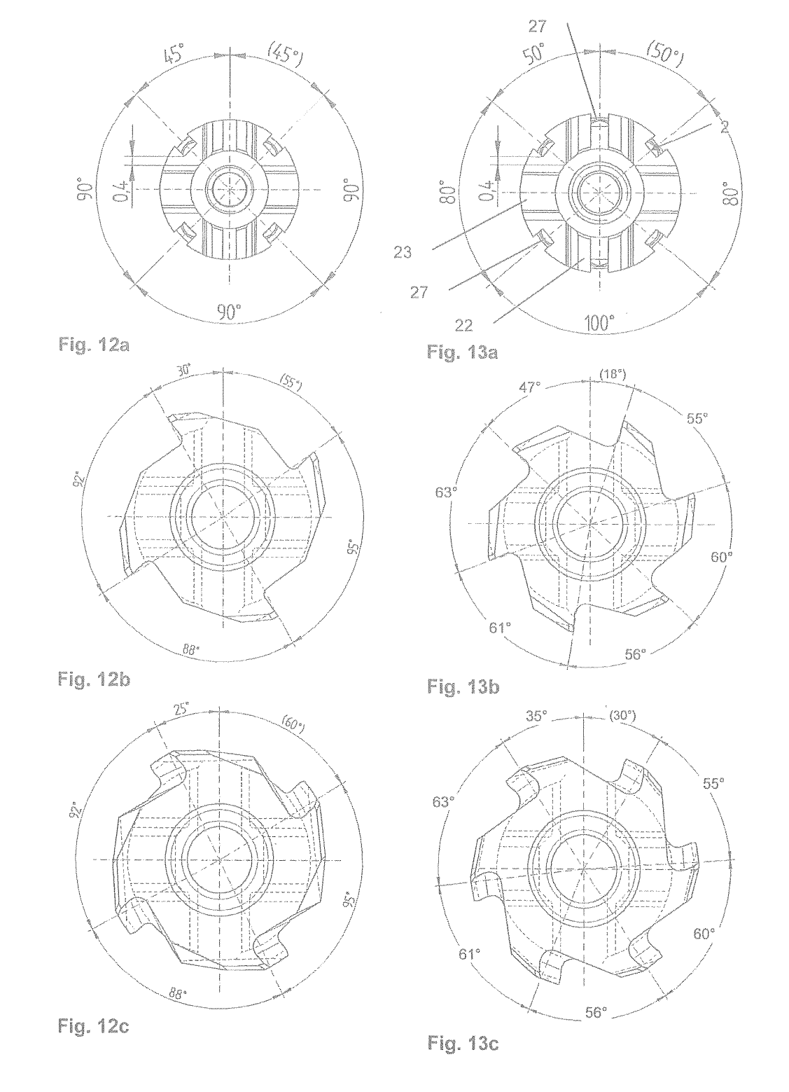

FIG. 12 shows divisions for an interchangeable head with a nominal diameter of 8 mm, for diameters of the finished cutter of approx. 8.1 mm to 6.9 mm

FIG. 13 shows divisions for an interchangeable head with a nominal diameter of 10 mm, for diameters of the finished cutter of approx 10.1 mm or 9.6 mm to 8.1 mm.

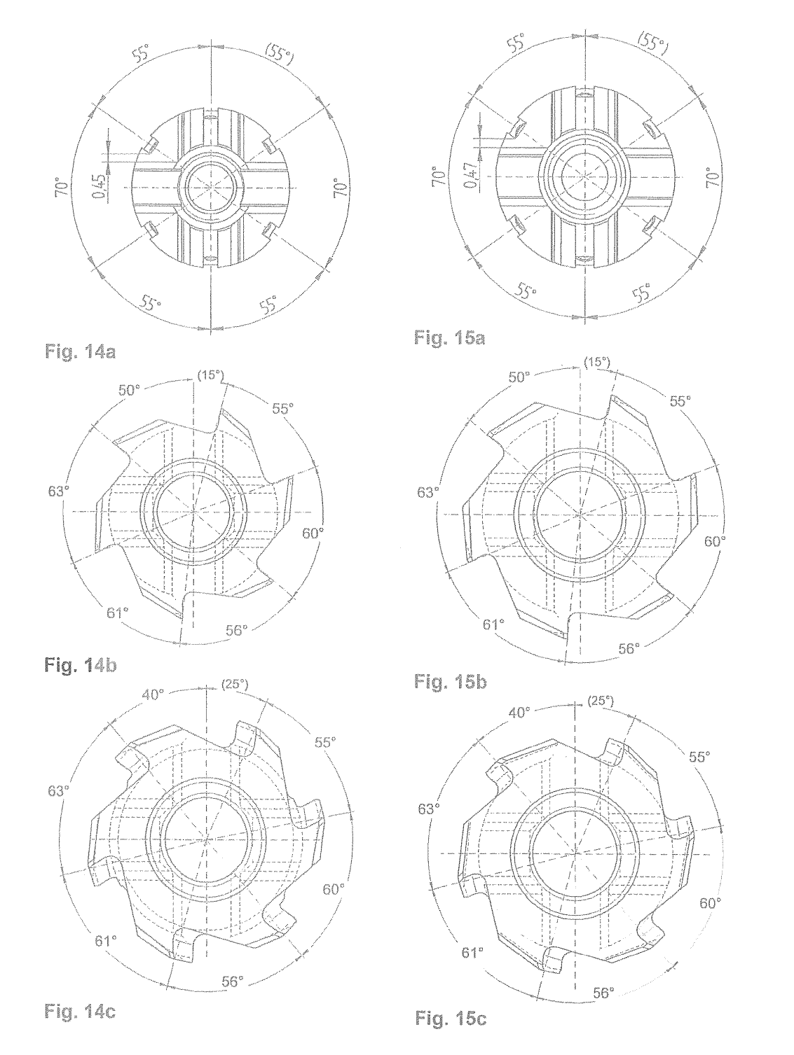

FIG. 14 shows divisions for an interchangeable head with a nominal diameter of 11 mm, for diameters of the finished cutter of approx. 11.1 to 9.6 mm.

FIG. 15 shows divisions for an interchangeable head with a nominal diameter of 13 mm, for diameters of the finished cutter of approx. 13.1 to 11.1 mm.

The angles of the divisions on the shank in the case of interchangeable heads with four teeth:

nominal diameter of the
interchangeable head

| | 7 mm | 8 mm |
|---|---|---|
| shank groove 22 to the first | 40° | 45° |
| coolant feed | | |
| first coolant feed to the second | 100° | 90° |
| one | | |
| second coolant feed to the third | 80° | 90° |
| one | | |
| third coolant feed to the fourth | 100° | 90° |
| one | | |

The angles of the division on the respective interchangeable heads are:

| | nominal diameter d/fluting v | | | |
|---|---|---|---|---|
| | 7 mm/ | 7 mm/ | 8 mm/ | 8 mm/ |
| | straight | helical | straight | helical |
| w: head ridge 13 to the first tooth | 30° | 25° | 30° | 25° |
| (primary cutting edge) | | | | |
| first tooth to second one | 92° | 92° | 92° | 92° |
| second tooth to third one | 88° | 88° | 88° | 88° |
| third tooth to fourth one | 95° | 95° | 95° | 95° |

The angles of the divisions on the shank in the case of interchangeable heads with six teeth:

| | nominal diameter of the | | |
|---|---|---|---|
| | interchangeable head | | |
| | 10 mm | 11 mm | 13 mm |
| shank groove 22 to the first | 0° | 0° | 0° |
| coolant feed | | | |
| first coolant feed to the second | 50° | 55° | 55° |
| one | | | |
| second coolant feed to the third | 80° | 70° | 70° |
| one | | | |
| third coolant feed to the fourth | 50° | 55° | 55° |
| one | | | |
| fourth coolant feed to the fifth | 50° | 55° | 55° |
| one | | | |
| fifth third coolant feed to the | 80° | 70° | 70° |
| sixth one | | | |

The angles of division on the respective interchangeable heads are:

| nominal diameter | 10 mm/ | 10 mm/ | 11 mm/ | 11 mm/ | 13 mm/ | 13 mm/ |
|---|---|---|---|---|---|---|
| d/fluting v | straight | helical | straight | helical | straight | helical |
| w: head ridge | 47° | 35° | 50° | 40° | 50° | 40° |
| 13 to the first | | | | | | |
| tooth (primary | | | | | | |
| cutting edge) | | | | | | |
| first tooth to the | 63° | 63° | 63° | 63° | 63° | 63° |
| second one | | | | | | |
| second tooth to | 61° | 61° | 61° | 61° | 61° | 61° |
| the third one | | | | | | |
| third tooth to | 56° | 56° | 56° | 56° | 56° | 56° |
| the fourth one | | | | | | |
| fourth tooth to | 60° | 60° | 60° | 60° | 60° | 60° |
| the fifth one | | | | | | |
| fifth tooth to | 55° | 55° | 55° | 55° | 55° | 55° |
| the sixth one | | | | | | |

1. A machine reaming tool comprising a shank and an interchangeable head, which is assembled on the shank, wherein
the interchangeable head on a side that faces the shank comprises at least one head groove and at least one head ridge,
the shank on a side that faces the interchangeable head comprises at least one shank groove and at least one shank ridge, and
in the assembled condition, the at least one head groove engages into the at least one shank ridge and the at least one shank groove engages into the at least one head ridge.

2. A machine reaming tool according to claim 1, wherein the grooves and ridges on the interchangeable head and on the shank each comprise oblique side walls, and in the assembled condition, a fastening element, which presses the interchangeable head in a direction towards the shank, presses the oblique side walls of the head groove against those of the shank ridge and the oblique side walls of the head ridge against those of the shank groove.

3. A machine reaming tool according to claim 1, wherein
two inner side walls of the head groove taper to one another in the direction of a base surface of the head groove and form two head groove contact surfaces, and two outer side walls of the head ridge taper to one another in the direction of an end face of the head ridge and form two head ridge contact surfaces;
two inner side walls of the shank groove taper to one another in the direction of a base surface of the shank groove and form two shank groove contact surfaces, and two outer side walls of the shank ridge taper to one another in the direction of the end-face of the shank ridge and form two shank ridge contact surfaces; and
in the assembled condition, the head groove contact surfaces lie on the shank ridge contact surfaces and the two head ridge contact surfaces lie on the shank groove contact surfaces.

4. A machine reaming tool according to claim 3, wherein
the two inner side walls of the head groove are plane, and two planes, in which the two inner side walls of the head groove lie, intersect at a line which intersects the rotation axis and lies normally to this;
the two outer side walls of the head ridge are plane, and two planes, in which the two outer side walls of the head ridge lie, intersect at a line which intersects the rotation axis and lies normally to this;
the two inner sides walls of the shank groove are plane, and two planes, in which the two inner side walls of the shank groove lie, intersect at a line which intersects the rotation axis and lies normally to this; and
the two outer side walls of the shank ridge are plane, and two planes, in which the two outer side walls of the shank ridge lie, intersect at a line which intersects the rotation axis and lies normally to this.

5. A machine reaming tool according to claim 2, wherein the shank ridge comprises a slot in the longitudinal direction and by way of this, in the assembled condition relative to the non-assembled condition, the outer side walls of the shank ridge are pressed against one another, the shank ridge is deformed and the slot is narrowed.

6. A machine reaming tool according to claim 1, wherein the head groove and the head ridge run normally to one another and the shank groove and the shank ridge run normally to one another.

7. An interchangeable head for a machine reaming tool comprising a rotation axis, wherein
at a side which is envisaged for assembly on a shank, the interchangeable head comprises at least one head groove and at least one head ridge.

8. An interchangeable head according to claim 7, wherein the head groove and the head ridge each comprise oblique side walls, and in particular
two inner sides walls of the head groove taper to one another in the direction of a base surface of the head groove and form two head groove contact surfaces, and two outer side walls of the head ridge taper to one another in the direction of an end face of the head ridge and form two head ridge contact surfaces.

9. An interchangeable head according to claim 8, wherein
the two inner sides walls of the head groove are plane, and two planes, in which the two inner side walls of the head groove lie, intersect at a line which intersects the rotation axis and lies normally to this;
the two outer side walls of the head ridge are plane, and two planes, in which the two outer side walls of the head ridge lie, intersect at a line which intersects the rotation axis and lies normally to this.

10. An interchangeable head according to claim 8, wherein the inner side walls of the head groove and/or the outer side walls of the head ridge are inclined by an angle of between 10° and 40° respect to the rotation axis.

11. An interchangeable head according to claim 7, with four teeth, with a diameter of 6 mm to 8 mm and with a straight fluting of the teeth, with which a division of the angles between the teeth has the following angles:
head ridge to first tooth: 30°;
first tooth to second one: 92°;
second tooth to third one: 88°;
third tooth to fourth one: 95°;

12. An interchangeable head according to claim 7, with four teeth, with a diameter of 6 mm to 8 mm and with a helical fluting of the teeth, with which a division of the angles between the teeth has the following angles:
head ridge to first tooth: 25°;
first tooth to second one: 92°;
second tooth to third one: 88°;
third tooth to fourth one: 95°;

13. An interchangeable head according to claim 7, with six teeth, with which a division of the angles between the teeth has the following angles:
first tooth to second one: 63°;
second tooth to third one: 61°;
third tooth to fourth one: 56°;
fourth tooth to fifth one: 60°;
fifth tooth to sixth one: 55°;
and with one of the following combinations of diameter d, fluting v and angle w between the head ridge and the first tooth:
d=8 mm to 10 mm, v=straight, w=47°;
d=8 mm to 10 mm, v=helical, w=35°;
d=9 mm to 11 mm, v=straight, w=50°;
d=9 mm to 11 mm, v=helical, w=40°;
d=11 mm to 13 mm, v=straight, w=50°;
d=11 mm to 13 mm, v=straight, w=40°.

14. A shank for a machine reaming tool, comprising a rotation axis, wherein
the shank at a side which is envisaged for assembly on an interchangeable head comprises at least one shank groove and at least one shank ridge.

15. The shank according to claim 14, wherein the shank ridge comprises a slot in the longitudinal direction, said slot extending into the shank ridge in a manner proceeding from the end-face of the shank ridge.

16. The shank according to claim 15, wherein a depth of the slot is at least as much as a height of the shank ridge beyond a shank end-face, from which the shank ridge rises.

17. The shank according to claim 14, which is manufactured from steel in a connecting region, on which the shank ridge is formed and is manufactured of a different material, in particular a hard metal, in a rear part of the shank.
